(19) United States
(12) Patent Application Publication
(10) Pub. No.: US 2022/0108334 A1
(43) Pub. Date: Apr. 7, 2022

(54) INFERRING UNOBSERVED EVENT PROBABILITIES

(71) Applicant: ADOBE INC., SANJOSE, CA (US)

(72) Inventors: AYUSH CHAUHAN, Meerut (IN); Aditya Anand, Chennai (IN); Sunny Dhamnani, Bellevue, WA (US); Shaddy Garg, Bagha Purana (IN); Shiv Kumar Saini, Bangalore (IN)

(21) Appl. No.: 17/060,723

(22) Filed: Oct. 1, 2020

(51) Int. Cl. G06Q 30/02; G06N 3/04; G06N 3/08; G06Q 10/06

(52) U.S. Cl. CPC G06Q 30/0202; G06N 3/04; G06Q 30/0246; G06Q 10/06375; G06N 3/08

(57) ABSTRACT

Systems and methods for data analytics are described. The systems and methods include receiving attribute data for at least one user, identifying a plurality of precursor events causally related to an observable target interaction with the at least one user, wherein at least one of the precursor events comprises a marketing event, predicting a probability for each of the precursor events based on the attribute data using a neural network trained with a first loss function comparing individual level training data for the observable target interaction, and performing the marketing event directed to the at least one user based at least in part on the predicted probabilities.

### BACKGROUND

The following relates generally to data analytics, and more specifically to data analytics performed using an artificial neural network (ANN).

Data analysis, or analytics, is the process of inspecting, cleaning, transforming and modeling data. In some cases, data analytics systems may include components for discovering useful information, collecting information, informing conclusions and supporting decision-making. Causal attribution is an area of data analytics that determines the amount of influence precursor events have on a resulting composite event. For example, causal attribution may be performed using data processing machines to determine the influence of an advertisement on subsequent customer behavior (i.e., marketing attribution).

Existing data processing machines use individual level data about the precursor events and the corresponding composite events to determine the relationship among them. However, in some cases, individual level data is not available. In these cases, conventional data processing machines will not provide accurate results.

For example, a data processing machine may use data analytics to determine the effectiveness of various marketing channels (e.g., search ads vs social media ads). If the available marketing data does not include information about individual events (e.g., whether an individual customers saw an ad), conventional data processing machine cannot accurately predict the importance of the different channels. In these cases, conventional data analytics tools will produce inaccurate results. This can result in lost time and money (e.g., due to misallocation of a marketing budget that is allocated based on marketing attribution data).

Therefore, there is a need in the art for improved systems and methods of causal attribution when individual level data is not available. In the marketing context, there is a need for improved data processing machines that provide accurate causal attribution about marketing events without relying on individual level data.

### SUMMARY

Systems and methods are described for performing data analytics. According to some embodiments, a neural network may be used to predict one or more unobserved precursor events (e.g., marketing events for which only aggregate data is available) based on observed individual level outcome data (e.g., whether a user clicks on a website). The neural network is trained using multiple training tasks. A first training task is based on a binary cross entropy (BCE) loss function applied to the predicted and observed values. A second training task uses an aggregate loss function based on available aggregate data for the unobserved precursor events. In some cases, a third training task is used to smooth aggregate level predictions over batches of data.

A method, apparatus, and non-transitory computer readable medium for data analytics are described. Embodiments of the method, apparatus, and non-transitory computer readable medium include receiving attribute data for at least one user, identifying a plurality of precursor events causally related to an observable target interaction with the at least one user, wherein at least one of the precursor events comprises a marketing event, predicting a probability for each of the precursor events based on the attribute data using a neural network trained with a first loss function comparing individual level training data for the observable target interaction, and performing the marketing event directed to the at least one user based at least in part on the predicted probabilities.

A method, apparatus, and non-transitory computer readable medium for training a neural network to perform data analytics are described. Embodiments of the method, apparatus, and non-transitory computer readable medium include receiving attribute data for a plurality of users, receiving individual level training data for the users corresponding to an observable target interaction causally related to a plurality of precursor events, predicting event data for each of the precursor events based on the attribute data, wherein the event data includes a probability of an occurrence of a corresponding precursor event, computing a product of the event data for each of the users, comparing the product of the event data to the individual level training data using a first loss function, and updating the neural network based on the comparison.

An apparatus and method for data analytics are described. Embodiments of the apparatus and method include an input component configured to receive attribute data for a plurality of users, and a neural network configured to predict a probability for each of a plurality of precursor events that are causally related to an observable target interaction with the users, wherein the neural network is trained using a first loss function comparing individual level training data for the observable target interaction.

### BRIEF DESCRIPTION OF THE DRAWINGS

FIG. 1 shows an example of a process for utilizing data analytics in a marketing campaign according to aspects of the present disclosure.

FIG. 2 shows an example of a system for data analytics according to aspects of the present disclosure.

FIG. 3 shows an example of a sequence of marketing events according to aspects of the present disclosure.

FIG. 4 shows an example of a data generation process according to aspects of the present disclosure.

FIG. 5 shows an example of a process for data analytics according to aspects of the present disclosure.

FIG. 6 shows an example of a method of training a neural network according to aspects of the present disclosure.

FIG. 7 shows an example of a method of providing an apparatus for data analytics according to aspects of the present disclosure.

### DETAILED DESCRIPTION

The present disclosure relates to systems and methods of data analytics. Embodiments of the inventive concept enable causal attribution when information about individual precursor events is not available. For example, at least one embodiment relates to a data processing system for automatically attributing influence to marketing events when data about certain marketing events is only available at an aggregate level. In some embodiments, a neural network is trained to perform attribution using multiple training tasks that utilize different kinds of training data.

Causal attribution refers to the data analytics task of determining the influence of precursor events on a subsequent composite event (i.e., an event that depends on multiple precursors). Conventional causal attribution techniques rely on individual level data about both the precursor events and the composite event. However, accurate causal attribution is more difficult when data about individual precursor events is not available.

Conventional systems for performing marketing attribution with missing individual level data simply assume the occurrence of a precursor event given the occurrence of the corresponding composite event. For example, if a user clicks on a paid search ad bringing them to a website, it may be assumed that the user went to the website because they saw the search ad. However, this method can attribute too much influence to a precursor event, thereby producing inaccurate results. For example, in some cases the composite event would occur without the influence of the precursor event. In the search ad context, some users may visit a website after a search even without viewing the ad.

Embodiments of the present disclosure include systems and methods to more accurately measure the impact of precursor events at an individual level when individual level data is not available. In one embodiment, a neural network model is used to infer the effect of multiple unobserved precursor events based on individual level data about observed composite events. A first training task for the neural network is based on a binary cross entropy (BCE) loss function applied to the predicted and observed values. The first training task trains the model to provide predictions that are consistent with observed individual level data.

In some embodiments, a second training task uses an aggregate loss function based on available aggregate data for the unobserved precursor events. The second training task trains the model to provide predictions that are consistent with aggregate level data for events that are unobserved at the individual level. In some cases, a third training task is used to smooth aggregate level predictions over multiple batches of data. The third training task may be used to prevent overfitting the model to specific portions of the training data.

By training a neural network to predict the influence of individual precursor events in the absence of individual level data for the precursor events, embodiments of the present disclosure enable improvements over conventional data analytics platforms. Embodiments of the present disclosure provide more efficient and accurate attribution of influence to precursor events, which enables users of a data analytics system to make better decisions. Furthermore, by collecting and processing data using a neural network, accurate results can be obtained in real time.

In some embodiments, improvements in data processing efficiencies are attained because processing to retrieve and recognize individual level data is minimized. Furthermore, improvements in accuracy in measuring the impact of precursor events enable users (e.g., marketers) of a data analytics system to make better and properly targeted decisions.

The technical problem of determining accurate causal attribution often arises in a marketing context. Therefore, some embodiments of the inventive concept relate to marketing attribution. In marketing, a brand interacts with customers via multiple channels. The channels may include one or more owned channels (e.g., company websites promoting the brand) as well as earned and paid channels (e.g., television ads, search ads, ads on social media platforms, and display ads on publishers' websites). In some cases, the marketing objective of using earned and paid channels is to bring the customers to owned channels. For example, a marketing campaign may involve bidding for search ads, displaying social media ads, or sending emails through email marketing vendors.

To make informed decisions, a marketer is interested in understanding a customer's actions on an individual level (e.g., whether customers searched for an ad, whether an ad is shown, and whether an ad is clicked on). Marketing attribution at an individual level may be based on data about unobserved events (i.e., precursor events) and observed events (i.e., composite outcome events). Causal inference refers to attempts to account for the unobserved events.

In some cases, the marketer may have direct access to web analytics such as website clicks, and these analytics may be tracked at an individual level. That is, the marketer may have information about the identity of each person who accesses or clicks on a website. Thus, the web analytics applications can provide individual level information about user behavior (i.e., observed events).

However, certain customer actions are unobserved. For example, some paid marketing channels (e.g., paid search or social media advertising) do not provide individual level data. That is, the marketer observes the results of marketing actions when customers visit an owned channel, but does not have individual level information related to paid channel. So the marketer may know how many people saw an ad, but may not know whether a particular person who visited a website previously viewed the ad.

The influence of unobserved channels may be difficult to detect. For example, it may be difficult to distinguish between the effects of a television ad, a marketing email, and an online ad if a customer may have been exposed to all of these channels at different times. Similarly, it may be difficult to determine the precise impact of different marketing efforts within a given channel. For example, if a customer searches for a company brand and click on a paid result, it may be difficult to determine whether they would have clicked on an unpaid search result absent the paid ad. If purchase decisions are attributed to the wrong marketing channels, marketing efforts may be directed to channels that are inefficient, which results in the loss of time and money.

According to an embodiment of the inventive concept, a neural network model may be used to generate predicted event data to refine targeting strategies on channels that are not owned by a brand. For example, the model may predict that customers largely click on ads after searching for a brand name, and that these customers would have clicked on unpaid search results without a paid advertisement.

This prediction enables a marketer to reduce spending on paid search ads and reallocate that portion of a marketing budget on other more effective marketing channels. In some examples, the described methods and systems can be applied to a marketing touch attribution setting. In other examples, the techniques described herein can be used to run simulations on marketing actions.

As used herein, the term “marketing” refers to activities taken by companies and individuals to encourage potential customers to purchase products or services. Marketing activities may take a variety of different forms, which may be referred to as marketing channels. A person or company may employ a variety of different marketing channels such as email, television, display, and social media to encourage sales.

The term “marketing attribution” refers to the task of determining the impact of a marketing channel. In a multi-channel marketing environment, a purchase decision is often based on a series of interactions such as e-mail, mobile, display advertising, and social media. These interactions have both direct, and indirect, influence on the final decisions of the customer. Marketers are responsible for determining how various marketing efforts affect a customer's final purchasing decision. A marketer can optimize an advertising budget by using a combination of interacting marketing channels.

The term “attribute data” refers to data about individual users, such as data about customers obtained based on observed user interactions on owned channels. Attribute data can include a history of interaction with a company or brand as well as demographic data and preference data for individual users.

The term “precursor event” refers to an event (which may or may not be observed) that leads to an observed outcome event. An example of a precursor event could be that a user searches for a term on a search engine, or views an ad as a result of performing a search. Another example may include a user viewing an ad on television or on a social media platform. Precursor events for which no data is available (or aggregate level data) may also be referred to as unobserved events.

The terms “outcome event” and “composite event” refer to an event related to a target outcome, which may be causally related to one or more precursor events. For example, the target outcome could be that a user visits a website asset owned by a company performing a marketing campaign. In some cases, individual level data (i.e., whether a specific user views a website) is available for the outcome event. An event for which such individual level data is available may also be known as an observed event.

The term “loss function” refers to a function that impacts how a machine learning model is trained in a supervised learning model. Specifically, during each training iteration, the output of the model is compared to the known annotation information in the training data. The loss function provides a value for how close the predicted annotation data is to the actual annotation data. After computing the loss function, the parameters of the model are updated accordingly, and a new set of predictions are made during the next iteration.

### System Overview

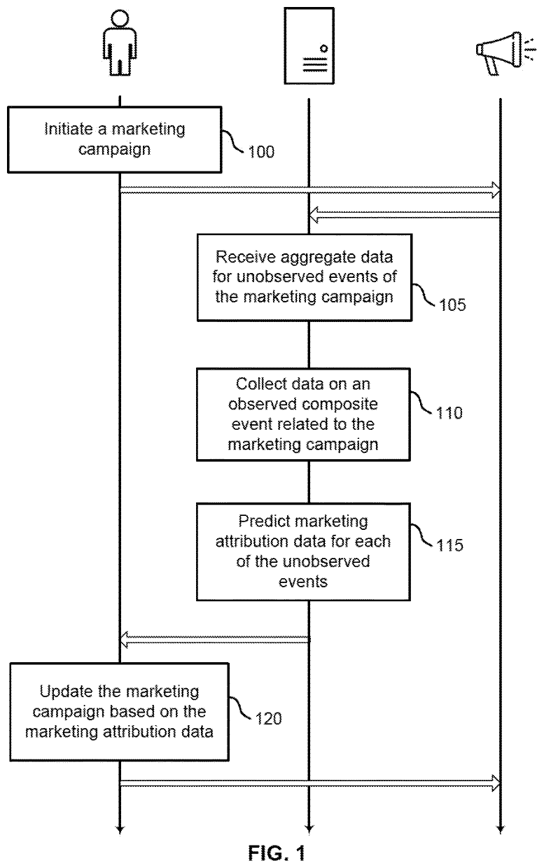

FIG. 1 shows an example of a process for utilizing data analytics in a marketing campaign according to aspects of the present disclosure. In some examples, these operations are performed by a data scientist or marketer interacting with data analytics system. The data analytics system may include a processor executing a set of codes to control functional elements of an apparatus.

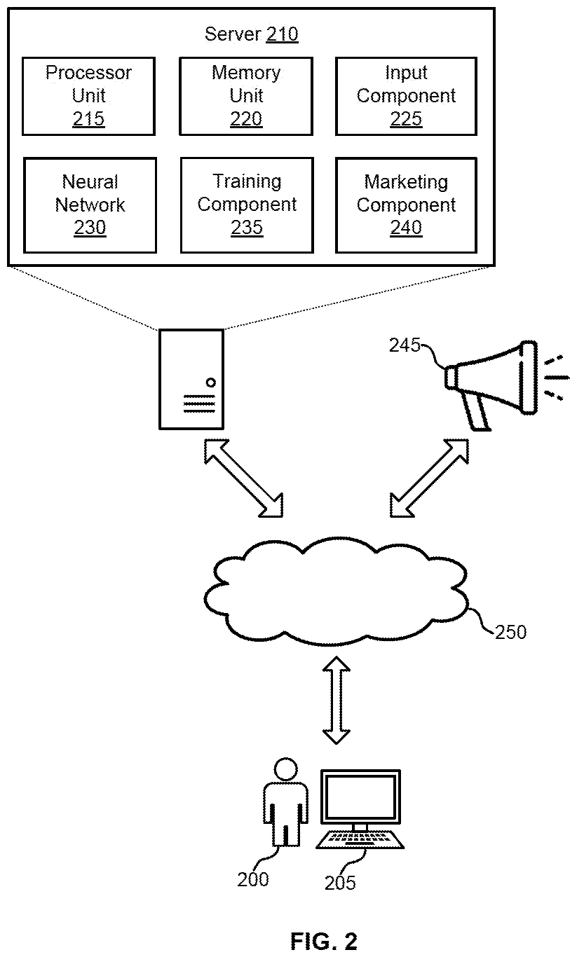

At operation 100, a business (or a marketing provider acting on behalf of a business) performs a marketing campaign. For example, marketer my provide a budget and other guidance or constraints to the marketing provider, who then presents ads to one or more users. In some cases, the marketing provider only provides aggregate level data about the results of the marketing campaign. The marketing campaign may include TV, radio, print, website advertisements, or any other form of advertisement. In some cases, detailed information about when individual users see the ad is not available. In some cases, the operations of this step may refer to, or be performed by, a marketing component as described with reference to FIG. 2.

In one example, a marketing provider performs marketing campaign for one or more products in some chosen geographic areas to increase revenue for sale of the one or more products. In some cases, the marketing provider presents a single ad to a large group of individuals through traditional media such as TV and print. This may be referred to as aggregate advertising.

At operation 105, the data analytics system receives aggregate data for unobserved events of the marketing campaign. In some cases, the operations of this step may refer to, or be performed by, an input component as described with reference to FIG. 2.

In some cases, a marketer observes composite events including customer interaction with their brand. These event can be a function of marketing actions (e.g., search ads or social media ads) that are unobserved as well as some actions from the customer that are observed (e.g., interactions with a website). With limited information available from a composite event, it may be difficult for the marketer to identify the precise probability functions of the unobserved events using conventional techniques. However, according to embodiments of the present disclosure, the unobserved events may be inferred from data to facilitate informed decision-making.

At operation 110, the data analytics system collects data on an observed composite event related to the marketing campaign. In some cases, the operations of this step may refer to, or be performed by, an input component as described with reference to FIG. 2.

According to an embodiment of the present disclosure, the data analytics system identifies one or more unobserved events related to an observed event (i.e., the composite event). Aggregate level targeting data may be available for the unobserved events. In some embodiments, the individual level data about the composite events and the aggregate data about the precursor events can be collected automatically. According to certain embodiments, the aggregate level data may be used to train a model for predicting the impact of individual unobserved events on the related composite event.

At operation 115, the data analytics system predicts marketing attribution data for each of the unobserved events. Embodiments of the present disclosure provide a method to infer more precise probabilities of the unobserved constituent events from the observed composite event or events when the targeting data is only available at an aggregate level. For example, a neural network may be trained using both individual level data (for observed events) and aggregate data (for unobserved events). In some cases, the operations of this step may refer to, or be performed by, a neural network as described with reference to FIG. 2.

When data such as individual level data about composite events is collected automatically, predictions about causal attribution may be made in real time using a pre-trained neural network model. Furthermore, by using a machine learning model, the predictions may be automatically and continuously improved as more data is collected.

At operation 120, the marketer (or the marketing provider) updates the marketing campaign for the marketer based on the marketing attribution data. Updating the marketing strategy may include reallocating budget among a variety of marketing channels, or among different regions or time periods to maximize a desired outcome. For example, if the attribution model suggests that one or more unobserved events (i.e., a customer's actions) are more likely to contribute to revenue realization of the business, marketing budget may be reallocated to those events or actions. In some cases, the operations of this step may refer to, or be performed by, a marketing component as described with reference to FIG. 2.

Embodiments of the present disclosure enable a marketer to measure the relationship between unobserved events and observed composite events. For example, using a neural network model, the marketer can estimate the impact of an unobserved event on observable website metrics (e.g., ad clicked, website visits, page views, etc.). The marketer can adjust a brand's investment in various marketing channels based on the predicted event data provided by the neural network model.

FIG. 2 shows an example of a system for data analytics according to aspects of the present disclosure. The example shown includes marketer 200, marketer device 205, server 210, marketing provider 245, and cloud 250. In one embodiment, server 210 includes processor unit 215, memory unit 220, input component 225, neural network 230, training component 235, and marketing component 240.

In one example, the marketer 200 manages a marketing campaign including marketing activities performed using the marketing provider 245. An application of the marketer device 205 may connect with the server 210 via the cloud 250 to directly monitor online activity of customers (e.g., website visits, clicks, or online sales). Additional information may be provided by the marketing provider 245.

In some cases, the impact of advertisements may be tracked directly using cookies or other online tracking mechanisms. However, in other cases, the effects of marketing activities are determined by receiving marketing data from the marketing provider 245 (e.g., a provider of TV advertisements or online search advertisements), and modeling the relationship between the online activity and the marketing data. Thus, in some cases aggregate marketing data is received indirectly (i.e., from a third party), and may not be as detailed as online activity data which may be monitored directly or in more detail. Therefore, according to embodiments of the present disclosure, the server 210 may predict unobserved events (e.g., marketing events performed by a third party) using the neural network 230 to enable more precise marketing attribution among various marketing actions.

In one example, the cloud 250 is a computer network configured to provide on-demand availability of computer system resources, such as data storage and computing power. In some examples, the cloud 250 provides resources without active management by the marketer. The term “cloud” may describe data centers available to many users over the Internet. Some large cloud networks have functions distributed over multiple locations from central servers. A server is designated an edge server if it has a direct or close connection to a user. In some cases, the cloud 250 is limited to a single organization. In other examples, the cloud 250 is available to many organizations. In one example, a cloud 250 includes a multi-layer communications network comprising multiple edge routers and core routers. In another example, a cloud 250 is based on a local collection of switches in a single physical location.

The server 210 provides one or more functions to users linked by way of one or more of the various networks. In some cases, the server 210 includes a single microprocessor board, which includes a microprocessor responsible for controlling all aspects of the server 210. In some cases, a server 210 uses a microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) could also be used. In some cases, a server 210 is configured to send and receive hypertext markup language (HTML) formatted files (e.g., for displaying web pages). In various embodiments, a server 210 comprises a general purpose computing device, a personal computer, a laptop computer, a mainframe computer, a supercomputer, or any other suitable processing apparatus.

The processor unit 215 is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the processor is configured to operate a memory array using a memory controller. In other cases, a memory controller is integrated into the processor. In some cases, the processor is configured to execute computer-readable instructions stored in a memory to perform various functions. In some embodiments, a processor includes special purpose components for modem processing, baseband processing, digital signal processing, or transmission processing.

Examples of a memory unit 220 include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

In some examples, server 210 includes an artificial neural network (ANN) for generating or representing regression models. An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. Each node and edge is associated with one or more node weights that determine how the signal is processed and transmitted.

During the training process, these weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

In some examples, server 210 includes a multi-layer perceptron (MLP). An MLP is a feed forward neural network that typically consists of multiple layers of perceptrons. Each component perceptron layer may include an input layer, one or more hidden layers, and an output layer. Each node may include a nonlinear activation function. An MLP may be trained using backpropagation (i.e., computing the gradient of the loss function with respect to the parameters).

According to some embodiments, input component 225 receives attribute data for a user 200 or a set of users (e.g., customers). In some examples, input component 225 collects interaction data for the marketer 200, where the attribute data is based on the interaction data. In some examples, input component 225 collects interaction data for users, where the attribute data is based on the interaction data. In some examples, input component 225 also receives individual level training data corresponding to an outcome event based on a set of precursor events, and aggregate level training data for at least one of the precursor events.

In some examples, marketing actions are executed through both owned and paid channels. In some cases, the input component 225 may receive a composite event (e.g., on an owned channel) including multiple events (e.g., that occur on a paid channel). These events include observed and unobserved events. Systems and methods of the present disclosure may be used to estimate the effect of unobserved events (e.g., showing a search ad) when individual level information is available for observed events (e.g., a search click). Thus, in one example, a search click is observed by a marketer when a customer searches for a brand name (e.g., using keywords), a brand shows an ad (e.g., displayed on resultant pages of search engines), and the customer clicks on the ad. A similar setting arises in numerous datasets where multiple actors interact. In such cases, direct inference may not be possible on one or more unobserved events.

Therefore, according to some embodiments, a neural network 230 predicts event data for each of a set of precursor events based on the attribute data, where the event data represents a probability of each of the precursor events. In some cases, the neural network 230 produces an output for each of the precursor events.

In some examples, the neural network 230 is trained using a first loss function that compares a function of the output to individual level training data for an outcome event that is based on the precursor events. In some examples, the function of the output includes a product of the output for each of the precursor events. In some examples, the first loss function includes a binary cross entropy function.

In some examples, the neural network 230 is also trained based on a second loss function that compares an aggregate output from a set of predictions to aggregate level training data for at least one of the precursor events. In some examples, the neural network 230 is trained based on a third loss function that smooths an aggregate loss term from the second loss function over a set of training batches.

In some examples, neural network 230 collects the individual level training data for the outcome event based on direct user interactions. In some examples, neural network 230 receives the aggregate level training data for the at least one of the precursor events from a third party.

In some examples, the neural network 230 includes a multi-layer perceptron (MLP) trained to estimate functions that determine the unobserved (or observed) event probabilities that constitute a composite event. In some cases, the output layer corresponding to constituent events is constrained between 0 and 1 using a softmax function. The predictions may be used to obtain a prediction for the observed composite event.

According to an embodiment, parameters of the network are updated based on a binary cross entropy (BCE) loss function applied to the predicted values and observed values of the composite event. The present disclosure describes how the scale using the aggregate level data is identified. The BCE loss identifies the unobserved events up to a scale. In one embodiment of the present disclosure, a custom loss function is used to train the neural network 230 based on the difference between the sample average of the estimated probabilities and the actual aggregate fractions. The aggregate loss function used in addition to a first loss function, learns the unobserved events at their respective correct scales. According to an embodiment, exponential smoothing is applied on the added custom loss across batches of data to avoid any drastic variation across these batches.

According to some embodiments, training component 235 computes a function of the event data for each of the users and compares the function of the event data to the individual level training data according to a first loss function. Then, training component 235 updates the neural network 230 based on the comparison. In some examples, the first loss function includes a BCE function.

In some examples, training component 235 also compares the predicted event data for the at least one of the precursor events to the aggregate level training data according to a second loss function, and the neural network 230 is further updated based on the comparison according to the second loss function. In some examples, training component 235 compares the predicted event data for the at least one of the precursor events over a set of training batches according to a third loss function.

According to an exemplary embodiment of the present disclosure, events of interest are identified based on information on the composite event and aggregate data on unobserved events (e.g., total number of search ads shown). Identification of the unobserved events' probabilities can be achieved up to a scalar factor under certain conditions. In an embodiment, a scalar factor (i.e., representing the probability of an event at an individual level) is identified using aggregate data that is available from aggregate data obtained from earned and paid channels (e.g., Facebook®, YouTube®, Google® etc.). The scalar factor is identified by the training component 235 using a combination of custom loss and the cross entropy loss.

According to some embodiments, marketing component 240 initiates at least one of the precursor events for the user (i.e., an ad targeted to the user) based on the predicted event data (i.e., based on a marketing strategy informed by the marketing attribution). In some examples, marketing component 240 updates a marketing strategy for the user 200 based on the predicted event data, where the at least one of the precursor events includes a marketing event. For example, a marketer can determine that the influence of an unobserved event on a purchase decision was less than previously thought and reduce the budget for that kind of marketing.

Therefore, embodiments of the present disclosure relate to identification of unobserved events from observed composite events. The marketer or marketing provider updates a marketing strategy based on the identification of unobserved events. For example, unobserved events include an email send based on interactions from a group of consumers. The unobserved events are not limited thereto. According to one embodiment, the neural network model is trained to predict the probabilities of the three unobserved events (e.g., email send, email open given email send, and email click given email open events) while a loss function is calculated based on observed events (e.g., email open, or email click).

### Event Causation

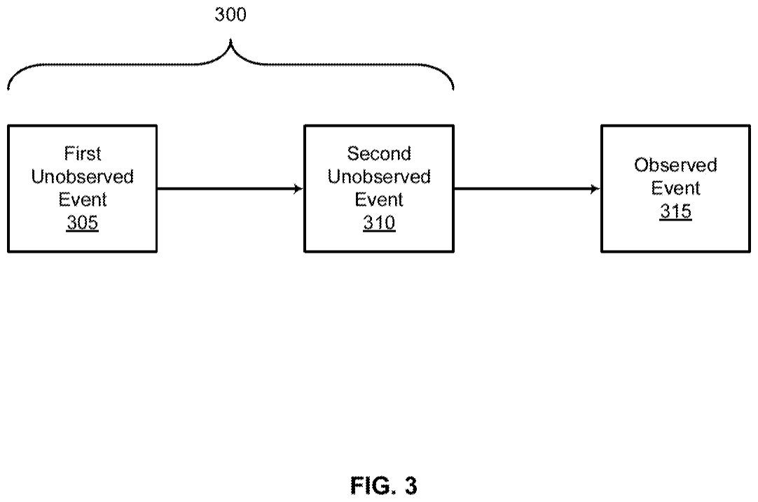

FIG. 3 shows an example of a sequence of events (e.g., marketing events) according to aspects of the present disclosure. The example shown includes unobserved events 300 (e.g., search events) and observed event 315 (e.g., ad click events).

In one embodiment, unobserved events 300 includes a first unobserved event 305 (e.g., a customer performs a search) and second unobserved event 310 (e.g., a customer views an ad). Thus, the first unobserved event 305 may include a customer search event. The second unobserved event 310 may include an ad shown event. Accordingly, the observed event 315 may include an ad click event.

For example, the ad click event can be observed by a web analytics system (e.g., Adobe® Analytics application). However, a marketer is also interested in knowing the impact of the ad that was shown. This depends on knowing data about which customers were not shown an ad (sometimes the data is not available). To make informed decisions, a marketer is interested in knowing things such as whether customers searched for the ad (e.g., keyword searching for the brand), an ad is shown, and/or an ad is clicked on. In some cases, web analytics tool observes if an ad is clicked (i.e., controllable).

However, the marketer may have a desire to estimate a probability of ad shown to customers. The marketer observes a composite event of interaction of their brand with the customers. The composite event is a function of some actions (e.g., marketing events) that are unobserved in data as well as some actions from the customer (e.g., search events) that may not be observed. According to an embodiment, the unobserved events may be inferred from the data to facilitate the marketer with informed decision-making.

According to an embodiment of the present disclosure, the composite functions observed in the data are functions of other observed and unobserved events of interest. One embodiment of the present disclosure makes use of independent variation in data that affects the two or more unobserved constituent events.

According to an embodiment, probability functions for observed events (i.e., a click) and unobserved events (i.e., ad shown) may be formulated as follows. P_{a,c}=P(Click=1,Ad Shown=1|X), P_{c}=P(Click=1|Ad Shown=1,X), and Pₐ=P(Ad Shown=1|X), where X is a vector of exogenous or pre-determined random variables. Then, P_{a,c}=P_{c}*Pₐ. A first task is to find out whether P_{c} and Pₐ are identifiable under set-up including firstly the event corresponding to P_{a,c} is observed in data, and secondly the events corresponding to P_{c} and Pₐ are not observed.

Let X₁, X₂⊆X be observed random vectors that determine P_{c} and Pₐ, respectively. The product determines P_{a,c}. Let P_{c}=f(X₁) and Pₐ=g(X₂). The composite event is formulated as follows:

P_{a,c}=f(x₁)*g(X₂)=h(X₁,X₂) (1)

Some embodiments of the present disclosure are based on conditions that enable identification of functions f(⋅) and g(⋅) given that the probability of the composite event is identified. According to a first condition, the estimate for the joint probability is of the form h(X₁,X₂)=f(X₁)*g(X₂). In some cases, h(X₁,X₂) can be estimated without error. In some embodiments, one can use a neural network to achieve a good approximation of h(X₁,X₂). When the event corresponding to h(X₁,X₂) is observed, this is not restrictive. According to a second condition, f(X₁), g(X₂)∈(0,1]∀X₁,X₂ in supp(X₁) and supp(X₂), respectively. According to a third condition, X₁ is strongly decomposable with respect to X₂. That is, X₁=X₁₁+X₁₂ such that X₁₁⊥X₁₂ and X₁₂⊥X₂. X₁₁ can be dependent on X₂. Also, supp(X₁₂) has full support. If P(X₁₁=0)=1, then X₁⊥X₂. According to a fourth condition, f(⋅)=1, g(⋅)=1 for at least some customers.

Given these conditions, (a) f(X₁) and g(X₂) may be identified up to a scale, (b) the scale parameter is such that

$$\frac{{f}^{′} ( {X}_{1} )}{f ( {X}_{1} )} = \frac{g ( {X}_{2} )}{{g}^{′} ( {X}_{2} )} = c ,$$

which is a constant. Here, f′(⋅) and g′(⋅) are the estimates of the functions f(X₁) and g(X₂), respectively. Since the joint probability can be estimated without error according to the first condition, h(X₁,X₂)=f′(X₁)*g′(X₂). This implies f′(X₁)*g′(X₂)=f(X₁)*g(X₂). Therefore, the following equation is obtained:

$$\frac{{f}^{′} ( {X}_{1} )}{f ( {X}_{1} )} = {( \frac{{g}^{′} ( {X}_{2} )}{g ( {X}_{2} )} )}^{- 1} \qquad ( 2 )$$

If the two ratios in left-hand side (LHS) and right-hand side (RHS) are not constants, these ratios will be functions of X₁=X₁₁+X₁₂ and X₂, respectively. It is possible to change X₁₂ and keep X₂ constant because X₁₂ and X₂ are independent. Since RHS is a constant for a fixed value of X₂, equation (2) implies that LHS is a constant with respect to the changes in X₁₂. Since X₁=X₁₁+X₁₂, and X₁₂ has full support, the LHS must be constant for all values of X₁.

In some cases that satisfy the fourth condition, c=1. That is, for c⁻¹*f′(X₁)=c*g′(X₂)=1, the value for c is 1 since in some cases the second condition is also applicable on f′(⋅) and g′(⋅). Thus, the two unobserved components are identified if the covariates determining the two events have independent components (the third condition). In addition, in absence of the assumption that the unobserved event probabilities are close to 1 (the fourth condition), the two functions are identified only up to a scale. To ensure the approach for identifying the unobserved events is useful, the scale parameter may be identified.

### Data Generation

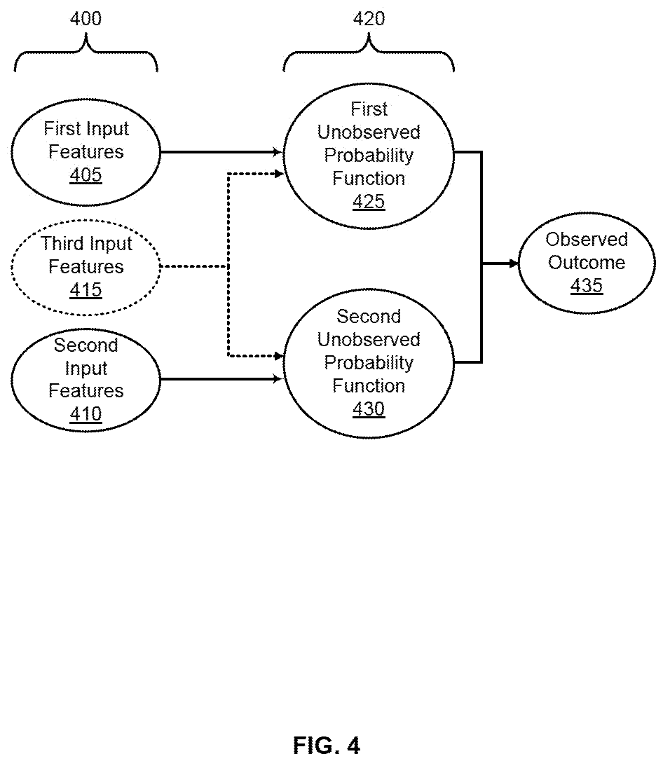

FIG. 4 shows an example of a data generation process according to aspects of the present disclosure. The example shown includes input features 400, unobserved probability functions 420, and observed outcome 435. In some cases, data may be generated synthetically to train or evaluate a neural network.

Input features 400 may include first input features 405, second input features 410, and in some cases, third input features 415. In one embodiment, unobserved probability functions 420 includes first unobserved probability function 425 and second unobserved probability function 430.

According to an embodiment of the present disclosure, the data includes four scalar input features denoted by X=(x₁,x₂,x₃,x₄)^{T}, two unobserved binary variables Y₁, Y₂, and one observed binary output variable Y. Each binary variable has an associated probability function which determines its value, 0 or 1. For Y₁ and Y₂ these are sigmoids of linear functions of the input features. The probability function for the observed outcome Y is the product of the probability functions for (Y₁=1) and (Y₂=1). The four features are sampled from zero mean Gaussian distributions with the standard deviations varying between 1 and 5.

In one embodiment, the total number of samples in the dataset are 100000 which are randomly divided into training, validation and test sets of sizes 55000, 20000 and 25000, respectively. Finally, Y, Y₁ and Y₂ are generated by performing Bernoulli trials with the respective probabilities.

There are different scenarios for testing and each scenario involves a different data generation process. The scenarios include independent covariates (“IND COV”), independent covariates but unknown (“IND COV UNK”), and partial overlap (“PAR OV”).

A first scenario is independent covariates. In this case, the features determining Y₁ and Y₂ are independent and the identity of the features that determine Y₁ and Y₂ is known. According to an example, the data generating process includes a case where the set of input features for Y₁ and Y₂ are mutually exclusive. Data generation process for synthetic data where P_{Y}=P_{Y}_{₁}*P_{Y}_{₂}.

The probabilities of Y₁ and Y₂ are functions of X₁={x₁,x₂} and X₂={x₃,x₄}, respectively. The probabilities and the binary variables are given by:

P_{Y}_{₁}=σ(w₁₀+w₁₁x₁+w₁₂x₂);Y₁= [symbol] (P_{Y}_{₁}) (3)

P_{Y}_{₂}=σ(w₂₀+w₂₃x₃+w₂₄x₄);Y₂= [symbol] (P_{Y}_{₂}) (4)

P_{Y}=P_{Y}_{₁}*P_{Y}_{₂};Y= [symbol] (P_{Y}) (5)

where P_{Y}_{₁}, P_{Y}_{₂}, P_{Y} are the probabilities P(Y₁=1), P(Y₂=1), P (Y=1), respectively and [symbol] (p) is Bernoulli trial with probability of success equal to p. According to an embodiment of the present disclosure, the first input features 405 include X₁, the second input features 410 include X₂. The first unobserved probability function 425 includes Y₁ and second unobserved probability function 430 includes Y₂. The observed outcome 435 includes Y.

A second scenario is independent covariates but unknown. In this case, the data generating process is the same whereby the two unobserved variables Y₁ and Y₂, are functions of mutually exclusive set of input features. One difference is that during modeling it is not known which input features determine which variable.

A third scenario is partial overlap. In this case, the two unobserved variables share some covariates but not all. The method is tested where some features are shared. One example shows the data generating process having X₁={x₁} and X, ={x₂,x₃} and X₂={x₄}. The probabilities and the binary variables are determined as follows:

P_{Y}_{₁}=σ(w₁₀+w₁₁x₁+w₁₂x₂+w₁₃x₃);Y₁= [symbol] (P_{Y}_{₁}) (6)

P_{Y}_{₂}=σ(w₂₀+w₂₂x₂+w₂₃x₃+w₂₄x₄);Y₂= [symbol] (P_{Y}_{₂}) (7)

P_{Y}=P_{Y}_{₁}*P_{Y}_{₂};Y= [symbol] (P_{Y}) (8)

The marketer or the marketing provider may not know which features determine which event. According to an embodiment of the present disclosure, the first input features 405 include X₁, the second input features 410 include X₂, and the third input features 415 include X_{c}. The first unobserved probability function 425 includes Y₁ and second unobserved probability function 430 includes Y₂. The observed outcome 435 includes Y.

Embodiments of the present disclosure allows a marketer to target customers in a data-driven manner by correctly identifying unobserved events in the targeting data. The observed composite functions in the data are functions of other observed and unobserved events of interest. Some embodiments make use of independent variation in data that affects the two or more unobserved constituent events.

### Inference

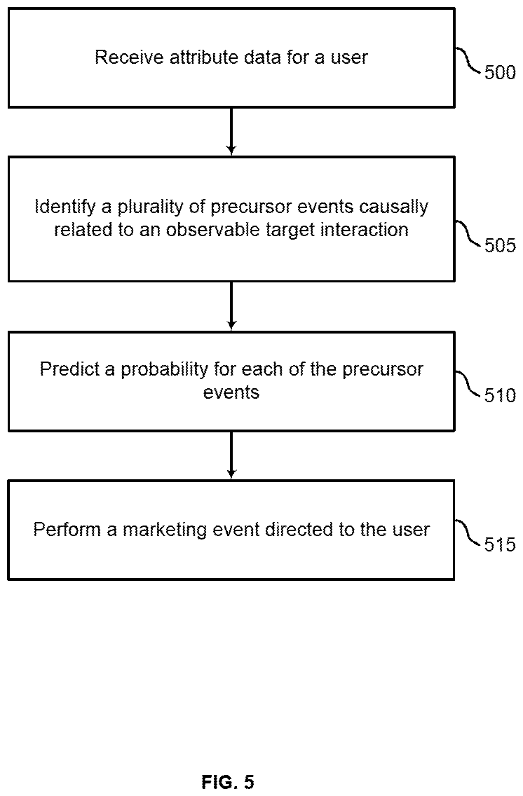

FIG. 5 shows an example of a process for data analytics according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 500, the system receives attribute data for a user (e.g., for a customer or a target of a communication). For example, the user may be someone that visits the website of a brand, and who may potentially purchase something. In some cases, the operations of this step may refer to, or be performed by, an input component as described with reference to FIG. 2.

At operation 505, the system identifies a plurality of precursor events causally related to an observable target interaction with the at least one user, wherein at least one of the precursor events comprises a marketing event. In many cases, the events estimated by f′(⋅) and g′(⋅) are not observed. However, it may be possible to obtain data at the aggregate level. For example, it is difficult to know which customer was shown a search ad, but it might be easy to have data on the fraction of customers who were shown a search ad. This information is used to identify the scale parameter of the unobserved events.

According to an embodiment of the present disclosure, the datasets used herein include synthetic data and/or customer behavior data. Customer behavior datasets include interactions of a group of customers with a brand and such interactions are recorded by web analytics tools.

At operation 510, the system predicts a probability for each of the precursor events based on the attribute data using a neural network trained with a first loss function comparing individual level training data for the observable target interaction. In some cases, the system predicts event data for each of the precursor events, where the event data represents a probability of each of the precursor events, and the event data is predicted using a neural network that produces an output for each of the precursor events. In some cases, the neural network is trained using a first loss function that compares a function of the output to individual level training data for an outcome event that is based on the precursor events. In some cases, the operations of this step may refer to, or be performed by, a neural network as described with reference to FIG. 2.

Embodiments of the present disclosure use a multi-layer perceptron (MLP) neural network architecture to estimate the functions f(⋅) and g(⋅) that determine the unobserved (or observed) event probabilities (P_{c} and Pₐ) that constitute the composite event (i.e., the observable target interaction). The output layer corresponding to these constituent events is constrained to be between 0 and 1 using a softmax function. These predictions help obtain a prediction for the observed composite event. According to an embodiment, the predicted value of P_{c}, is obtained as a simple product of the predictions for P_{c} and Pₐ. The network parameters are then updated based on a binary cross entropy (BCE) loss function applied to the predicted and observed values of the composite event.

According to an embodiment of the present disclosure, the BCE loss is able to identify the unobserved events up to a scale. In some cases, the scale parameter is identified using the aggregate level data. One embodiment of the present disclosure provides a custom loss term based on the difference between the sample average of the estimated probabilities and the actual aggregate fractions. The aggregate loss term, added to the BCE loss function, helps learn the unobserved events at their correct scales. Further, one embodiment performs exponential smoothing of the added term across batches of data to avoid any potentially drastic variation across these batches. Different training strategies may be based on different combinations of these loss functions.

At operation 515, the system initiates at least one of the precursor events for the user based on the predicted event data. In some cases, the system performs a marketing event directed to the at least one user based at least in part on the predicted probabilities For example, a marketing provider may initiate a marketing activity (or update a marketing strategy) based on the improved marketing attribution available by predicting individual level data for unobserved events. In some cases, the operations of this step may refer to, or be performed by, a marketing component as described with reference to FIG. 2.

According to an embodiment of the present disclosure, a neural network predicts at least one of the precursor events for the user based on the predicted event data. Accordingly, the method can be applied to data analytics tools (e.g., Adobe® Analytics) to optimize marketing expenditure. Using the method and neural network provided herein, marketers are able to measure the impact of what is actionable from initially unobserved events including whether an ad is shown, an email is sent, an email is open, etc. A marketer or a marketing provider updates his targeting strategies on the channels that are not owned by a brand. The neural network of the present disclosure can be applied in marketing touch attribution setting or used for running simulations on marketing actions.

### Training

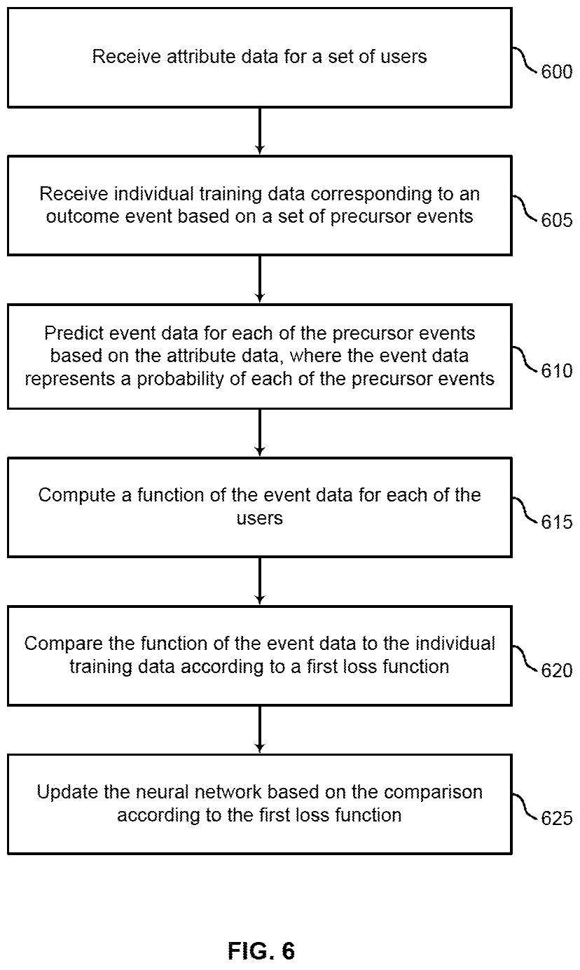

FIG. 6 shows an example of a method of training a neural network according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 600, the system receives attribute data for a set of users. In some cases, the operations of this step may refer to, or be performed by, an input component as described with reference to FIG. 2.

In some examples, the training data includes synthetic data generated as described above with reference to FIG. 4. In some examples, the attribute data for a set of users includes actual customer behavior data (or demographic data, or other user attribute data). There are multiple sources of data that record interactions and transaction between a business entity and its customers. These interactions are recorded in four different data sources such as web-analytics data, display ad impression data, email interaction data, and product usage data. These data sources are merged. Web-analytics data is stored in the form of a clickstream that records the online activities of a customer on the website (e.g., a data analytics application).

In some cases, one row of data represents each URL visited on the company's website (i.e., a brand). These visits include pages with information on the product features, product help, download trial versions or checkout. Each row contains information about the customer's device, geography, source of visit, URL, time-stamp, product purchased, etc. The visits from the search channel are recorded in the web-analytics dataset as well. When a customer performs keyword search on a browser, the company may decide to algorithmically bid on the search keyword. A link to the firm's online properties may be shown to the customer through a search ad or an organic link. Once the customer clicks on the link, the data is recorded in the company's clickstream.

In another example, the email interaction dataset includes information related to the emails sent by the organization to its customers. The dataset includes information such as whether a customer opened the email, clicked on a link in the email, unsubscribed to emails from the company, description of the email, etc. For example, experiments on email data have been carried out on a group of 174059 customers. Out of the group of customers, 38539 were sent an email, 28041 had opened the email and 1873 had clicked on the email. All three events (i.e., Email Sent, Email opened, Email clicked) are observed in the data. In the experiments, Email Sent event is hidden from the algorithm and used only for validation of the method. The web-analytics dataset is used to create features to predict email-related events of interest.

In yet another example, product usage data contains information on a customer's interactions with web analytics applications. Each row of the data stores information on the events such as application launch, application download, etc. Each dataset uses the same identifier for the customer and the identifier is used for merging the datasets.

At operation 605, the system receives individual level training data corresponding to an outcome event based on a set of precursor events. In some cases, the operations of this step may refer to, or be performed by, an input component as described with reference to FIG. 2.

In some examples, a two-period approach may be used for feature creation. That is, for each customer, features are constructed (i.e., using a neural network encoder) from the user interaction with the brand for a fixed period and evaluations are done for observations post this period. The data includes various events such as when a customer downloaded an app, the customer was shown an ad, the customer clicked on a paid search, etc.

According to an example, for each customer, 144 features from this data are extracted and each of the features is a measure of customer interaction for a particular event. Every experiment uses these 144 features to predict outcomes. For example, using the information of when customers were sent email, features for updated progress of email sent, frequency (the number of times a customer was sent email over the period of analysis) are constructed. According to an example, each row of the data contains 144 customer features, email sent, email opened, email clicked during the post feature creation period.

At operation 610, the system predicts event data for each of the precursor events based on the attribute data, where the event data represents a probability of each of the precursor events. In some cases, the operations of this step may refer to, or be performed by, a neural network as described with reference to FIG. 2.

For example, probabilities of the unobserved constituent events may be inferred from the observed composite events when the targeting data is only available at an aggregate level. The marketer observes a composite event of interaction of their brand with the customers. This event is a function of some actions from the marketer that are unobserved in data as well as some actions from the customer that may not be observed. Using the neural network of the present disclosure, a marketer can predict event data for each of the precursor events based on the attribute data, where the event data represents a probability of each of the precursor events (i.e., identify the probability functions of the unobserved events). Aggregate level targeting data is available which could be useful in correcting errors in the inference lack of it.

At operation 615, the system computes a function of the event data for each of the users. In some cases, the operations of this step may refer to, or be performed by, a training component as described with reference to FIG. 2.

In some embodiments, the event data represents a probability of each of the precursor events, such as P_{a,c}=P(Click=1,Ad Shown=1|X), P_{c}=P(Click=1|Ad Shown=1,X), and Pₐ=P(Ad Shown=1|X), where X is a vector of exogenous or pre-determined random variables. In some cases, the event corresponding to P_{a,c} is observed, and events corresponding to P_{c} and Pₐ are not observed. The observed event is a function of the unobserved events, P_{a,c}=P_{c}*Pₐ.

According to an embodiment of the present disclosure, the unobserved components determining P_{c} and Pₐ are identifiable if the covariates determining the two events have non-zero independent components. The unobserved events are identified up to a scale unless the probability of the two events, P_{c} and Pₐ are both arbitrarily close to one for a few customers. This is not likely since these events are rare.

In addition, one embodiment identifies the scale factor of the unobserved events. Even though these events are unobserved, it is possible to obtain data at the aggregate level. For example, a marketer may not know which customer was shown a search ad, but the marketer has access to data on the fraction of customers who were shown a search ad. The information is used to identify the scale parameter of the unobserved events.

At operation 620, the system compares the function of the event data to the individual level training data according to a first loss function. In some cases, the operations of this step may refer to, or be performed by, a training component as described with reference to FIG. 2.

Different training strategies include different loss functions. According to an exemplary embodiment of the present disclosure, a binary cross entropy loss function (BCEL) is used for each of the observed variables and the network model sums up the BCE loss:

$${ℒ}_{b} = {\sum }_{Y ∈ 𝓎} \frac{1}{\vert {η}_{b} \vert} {\sum }_{i ∈ {η}_{b}} - \{ {y}^{i} * log ( {\hat{P}}_{Y}^{i} ) + ( 1 - {y}^{i} ) * log ( 1 - {\hat{P}}_{Y}^{i} ) \} \qquad ( 9 )$$

where [symbol] _{b} is the BCE loss of data batch b, η_{b} is the set of data samples in b, [symbol] is the set of all observed variables, yⁱ is the true value of the i^{th} sample of variable Y and \hat{P}_{Y}ⁱ is the estimate of P_{Y}, the probability P(Y=1). \hat{P}_{Y}ⁱ may be obtained by computing the product of the estimated probabilities of other observed and unobserved variables.

At operation 625, the system updates the neural network based on the comparison according to the first loss function. In some cases, the operations of this step may refer to, or be performed by, a training component as described with reference to FIG. 2.

According to an embodiment, the scale of the unobserved events is not identified without the fourth condition. An additional aggregate loss term (AGGL) is added to the loss function to enable the model to learn the event probabilities at the correct scale factor. This loss term is based on the difference in the estimated and actual probabilities at the aggregate level. It is calculated as follows:

Δ_{b}=(P_{Y1}−\hat{P}_{Y1}^{b})²+(P_{Y2}−\hat{P}_{Y2}^{b})² (10)

where Δ_{b} is the aggregate loss of batch b, P_{Yj} is the actual aggregate probability of the event (Yⱼ=1), i.e., fraction of all samples where variable Yⱼ=1, \hat{P}_{Yj}^{b}=|η_{b}|⁻¹Σ_{i∈η}_{_{b}}\hat{P}_{Yj}ⁱ is the estimated value of the same aggregate probability over batch b.

The overall loss function in this case is [symbol] _{b}+λΔ_{b} for some constant weight λ. Minimization of the loss function with aggregate loss, Δ_{b} over each training batch allows identification of correct scale of the probabilities of the unobserved events.

According to an embodiment, the loss function takes exponential smoothing of the aggregate loss term (SAGG) Δ_{b} over different mini-batches of data. The experiments estimate low probability events, the aggregate loss could vary drastically across batches and hence smoothing may be performed by modifying the estimated aggregate probability to \hat{P}_{Yj}^{sb}.

$${\hat{P}}_{Y j}^{s b} = \{ \begin{matrix}{\hat{P}}_{Yj}^{b} , if b = 0 \\ α * {\hat{P}}_{Y j}^{b} + ( 1 - α ) * {\hat{P}}_{Y j}^{s b - 1} , otherwise\end{matrix} \qquad ( 11 )$$

where a is the smoothing weight and \hat{P}_{Yj}^{sb} is the smoothed version of the estimated aggregate probability.

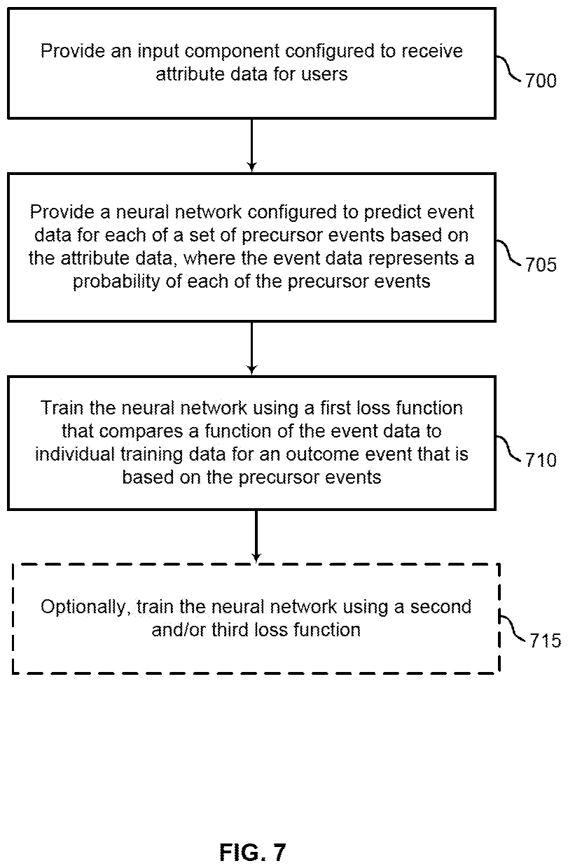

FIG. 7 shows an example of a method of providing an apparatus for data analytics according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 700, the system provides an input component configured to receive attribute data for users. In some cases, the operations of this step may refer to, or be performed by, an input component as described with reference to FIG. 2.

According to an embodiment of the present disclosure, attribute data (e.g., synthetic data) includes four scalar input features X=(x₁,x₂,x₃,x₄)^{T}, two unobserved binary variables Y₁, Y₂, and one observed binary output variable Y. Each binary variable has an associated probability function which determines its value, 0 or 1. For Y₁ and Y₂, these are sigmoids of linear functions of the input features. The probability function for the observed outcome Y is the product of the probability functions for (Y₁=1) and (Y₂=1). The four features are sampled from zero mean Gaussian distributions with standard deviations varying between 1 and 5. The total number of samples in the dataset are 100000. Finally, Y, Y₁ and Y₂ are generated by performing Bernoulli trials with the respective probabilities.

At operation 705, the system provides a neural network configured to predict event data for each of a set of precursor events based on the attribute data, where the event data represents a probability of each of the precursor events. In some cases, the operations of this step may refer to, or be performed by, a neural network as described with reference to FIG. 2.

According to some embodiments, an MLP network is used to estimate the unobserved events that constitute the observed composite event. The network model is trained using a loss function defined on the composite event.

In some cases, a fully connected MLP network is used to predict the probabilities of the unobserved events. The neural network includes three separate and fully connected units, each of which having four hidden layers of size 70, 40, 20 and 10, respectively and a single output node. Each unit learns to predict one of the three unobserved events. The probabilities of the two observed events are estimated from the predicted outputs.

In some cases, a custom loss function is provided based on aggregate targeting data to identify the correct scale parameter of the unobserved events. The aggregate loss term enforces a soft constraint on a model to estimate individual level probabilities.

At operation 710, the system trains the neural network using a first loss function that compares a function of the event data to individual level training data for an outcome event that is based on the precursor events. In some cases, the operations of this step may refer to, or be performed by, a training component as described with reference to FIG. 2.

In some cases, as in operation 715, the system may train the neural network using a second loss function based on comparing the output of the neural network to aggregate level data about the precursor events. A third loss function may be used to smooth the training over batches of aggregate data.

According to an embodiment of the present disclosure, training the neural network includes using customer behavior data. The customer behavior data is based on recorded interactions of customers (e.g., from an owned website). For example, a business may focus its marketing efforts on digital channels. The interaction events are recorded in multiple data sources such as web-analytics data, email interaction data, etc. Each dataset uses a same identifier for the customer and the same identifier is used to merge the datasets. The email interaction dataset includes information related to emails sent by the organization to its customers. This includes information such as whether a customer opened the email, clicked on a link in the email, unsubscribed to emails from the company, description of the email, etc.

### Evaluation

A customer behavior dataset may be used to validate the methods on real data.

Synthetically generated datasets may also be used to validate the disclosed methods. In synthetically generated data, robustness of the method is tested under different settings.

Experiments on email data have been conducted on a group of 174,059 customers. Out of the group of customers, 38,539 were sent an email, 28,041 had opened the email and 1,873 had clicked on the email. All three events are observed in the data. Feature creation process includes 144 features extracted from the data for each customer such that each feature is a measure of customer interaction for a particular event.

Since all the events are observed in this customer behavior email dataset, a realistic setting is simulated where email send is not observed in analytics data. According to an embodiment of the present disclosure, one event is artificially hidden from the network model during training and then used as ground truth for evaluation. The network model is trained to predict the probabilities of the three unobserved events (i.e., email send, email open given email send, and email click given email open) while the BCE loss (i.e., the first loss function) is calculated on the observed events (i.e., email open and email click).

Multiple training strategies may be tested including a binary cross entropy loss function (BCEL), additional aggregate loss function (AGGL), and smoothing of the aggregate loss function (SAGG). In one embodiment, performance is tested under different settings of the third condition. The estimation results are evaluated by comparing the predicted and actual probability of each variable in test data. The correctness of the predicted value is evaluated by error metrics, mean square error (MSE) and mean absolute percentage error (MAPE). MSE and MAPE are defined as follows, respectively:

$$\begin{matrix}MSE = \frac{1}{\vert {η}_{t} \vert} {\sum }_{i ∈ {η}_{t}} {( {P}_{Y j}^{i} - {\hat{P}}_{Y j}^{i} )}^{2} & ( 12 ) \\ MAPE = \frac{1}{\vert {η}_{t} \vert} {\sum }_{i ∈ {η}_{t}} \frac{\vert {P}_{Y j}^{i} - {\hat{P}}_{Y j}^{i} \vert}{{P}_{Y j}^{i}} & ( 13 )\end{matrix}$$

where ηₜ is the set of all test samples, P_{Yj}ⁱ is the actual probability of Yⱼ for the i^{th} sample and \hat{P}_{Yj}ⁱ is the corresponding estimated probability.

The method above has been validated on the synthetic data generated for the three cases (independent covariates, independent covariates but unknown, and partial overlap). The model in each of the cases has two nodes in the output layer to predict the probability of Y₁ and Y₂, respectively. The loss is defined on the product of the two outputs which is observed as Y in the data. The training is run for 150 epochs on batches of 128 data samples and the trained model at epoch with minimum validation loss is selected for testing. Although the models are trained using the observed binary variable Y, the performance of these models is evaluated by validating against the underlying true probabilities of all three variables, i.e., P_{Y}, P_{Y}_{₁}, P_{Y}_{₂}.

The method has also been evaluated on synthetic data in different scenarios. For example, if the two set of covariates are known to independently determine the unobserved variables Y₁ and Y₂, two separate and fully connected MLP networks may be trained to learn Y₁ from {x₁,x₂} and Y₂ from {x₃,x₄}, respectively, as described with reference to FIG. 4. Both the networks may have a single hidden layer of three nodes with ReLU activation function and one output node with sigmoid activation.

If the independence of relationship on the covariates is assumed to be unknown (but existing), the network architecture may be a fully connected MLP with all the input features connected to both the unobserved variables. The network may have a single hidden layer of size 3 and ReLU activation function while the output layer has two nodes with Sigmoid activation. In some cases, the two unobserved variables cannot be determined independently.

In a first set of synthetic data experiments, three training strategies in the above cases are compared without the fourth condition. According to an example, P_{Y}_{₁} and P_{Y}_{₂} are set to a maximum of 0.6 (i.e., representing low probability events). In addition, another experiment is conducted to test the performance of the model if the scale is identified correctly, when P_{Y}_{₁}, P_{Y}_{₂} and hence P_{Y} are all equal to 1 for at least some instances.

According to an embodiment, the method is tested on customer behavior data including brand-customer interactions. Experiments are performed on the Email dataset where all the three variables corresponding to the actions {Email Send, Email Open, Email Click} are observed in the data.

In some cases, an analyst has access to the data on {Email Open} and {Email Click} as these are customer actions easily recorded by analytics tools, whereas the event {Email Send} is unobserved to him as it is performed by the marketer. To simulate this setting, {Email Send} is artificially hidden from the model during training (i.e., artificially suppressing the observed data in the dataset). The model is therefore trained to predict the probabilities of the three unobserved events {Email Send, Email Open|Send, Email Click|Open} while the BCE loss [symbol] _{b} is calculated on the observed events {Email Open, Email Click}. The estimated probability of the observed events is as follows:

P[Open]=P[Send]*P[Open|Send] (14)

P[Click]=P[Open]*P[Click|Open] (15)

The network has three separate and fully connected units, each of which has four hidden layers of size 70, 40, 20 and 10, respectively and a single output node. Each unit learns to predict one of the three unobserved events. The probabilities of the two events observed by the algorithm are estimated as in equations 14 and 15.

The dataset is broken down into training, validation and test sets of 95297, 35247 and 43515 customers, respectively. The training is run for a maximum of 50 epochs on batches of 1024 instances, while the validation loss is used to select and return the best model. The performance of the model is evaluated in terms of MSE and MAPE between the predicted and ground truth probabilities of the five variables. To generate the ground truth probabilities, a XGBoost classifier is trained on the three events observed in data and probabilities of the other two events are obtained using equations 14 and 15.

XGBoost is a decision-tree-based machine learning algorithm that uses a gradient boosting framework. Gradient boosting is a supervised learning algorithm, which attempts to accurately predict a target variable by combining the estimates of a set of simpler, weaker models. The term “gradient boosting” refers to a gradient descent algorithm that is used to minimize the loss when adding new models.

The estimated probabilities are compared to the ground truth for prediction, had {Email Send} been observed. In the AGGL training scenario, the aggregate loss term Δ_{b} includes the sample average of the five variables, obtained using the ground truth classifier model.

For all the experiments involving exponential smoothing, a fixed value of the smoothing parameter α=0.8 is used. Other parameters such as the relative weight λ of the aggregate loss Δ_{b} are tuned manually using grid search.

MSE and MAPE for Y, Y₁, Y₂ are computed and compared using the three training strategies in all the scenarios of synthetic data in absence of the fourth condition. In some cases, MSE values are reported as parts per thousand, i.e., multiplied by 10³. MAPE values are reported as percentages, i.e., multiplied by 10².

The results illustrate that the method of using an aggregate loss reduces the estimation error as measured by the MSE and MAPE manifolds. This is true when the fourth condition is not satisfied. Hence, the probabilities of the unobserved events are identified only up to a scale with simple BCE loss. This is corroborated by the large values of MAPE under BCEL as MAPE is a good indicator for correct identification of scale. Adding the aggregate loss and smoothing process lead to improved performance which is attributed to correct identification of the scale factor. AGGL or SAGG yields the best performance in all the scenarios of synthetic data across the three variables. On average, AGGL provides an 52% reduction in MSE and 53% reduction in MAPE over BCEL. This is true when the fourth condition does not hold.

MSE and MAPE for Y, Y₁, Y₂ using the three training strategies in all the scenarios of synthetic data under the fourth condition is illustrated (i.e., when the fourth condition holds). The results show that providing additional information to the model in the form of aggregate averages for the unobserved event is beneficial even when the probabilities for the unobserved events are identified. The benefit of adding the aggregate loss term is minimal in the unrealistic case where the covariates that determine the two events are independent and known. For the other two realistic cases, the MSE and MAPE errors are reduced on average by 33% and 28%, respectively. This is significant improvement over the baseline, albeit much smaller than the improvement in results when the unobserved probabilities are identified only up to a scale. Thus, the synthetic data experiment supports the theoretical results and validates the method of identifying the scale.

According to an embodiment, the method is validated on customer behavior email data. MSE and MAPE for all the variables in the email data are computed and compared using the three training strategies. In some cases, MSE values are reported as percentages, i.e., multiplied by 10².

The validation results on the Email data in terms of MSE and MAPE are shown. As seen in the results on synthetic data, the method of adding the aggregate loss term performs much better in identifying the unobserved event probabilities. It performs well for the observed events as well, but the improvement is much larger in case of unobserved events. In particular, the methods AGGL and SAGG reduce MAPE which indicates the method is successful in identifying the scale factor correctly. On average over the five variables, AGGL reduces the MSE by 17% and MAPE errors by 46% compared to BCEL.

In summary, the systems and methods of the present disclosure have been validated on data showing 36% to 44% reduction in error on average, as measured by MSE and MAPE, respectively, over a baseline approach for the most realistic setting. For other settings, the results perform better. The method is also applied on a real email marketing dataset where it reduces MSE by 69% for unobserved probabilities of {Email Send} and by 14% for the unobserved probabilities of {Email Open given Email Send}.

Marketers spend more and more money on earned and paid channels having unobserved marketing events. The present disclosure provides methods and systems to identify unobserved events from an observed composite event, which is based on multiple unobserved or observed events. The neural network model can be applied in marketing touch attribution setting or used to run simulations on marketing actions. The method also allows inference on events in customer-brand interaction setting. The present disclosure improves targeting strategies on the channels that are not owned by a brand without compromising privacy by using aggregate data.

Accordingly, the present disclosure includes at least the following embodiments.

A method for data analytics is described. Embodiments of the method include receiving attribute data for a user, predicting event data for each of a plurality of precursor events based on the attribute data, wherein the event data represents a probability of each of the precursor events, the event data is predicted using a neural network that produces an output for each of the precursor events, and the neural network is trained using a first loss function that compares a function of the output to individual level training data for an outcome event that is based at least in part on the precursor events, and initiating at least one of the precursor events for the user based on the predicted event data.

An apparatus for data analytics is described. The apparatus includes a processor, memory in electronic communication with the processor, and instructions stored in the memory. The instructions are operable to cause the processor to receive attribute data for a user, predict event data for each of a plurality of precursor events based on the attribute data, wherein the event data represents a probability of each of the precursor events, the event data is predicted using a neural network that produces an output for each of the precursor events, and the neural network is trained using a first loss function that compares a function of the output to individual level training data for an outcome event that is based at least in part on the precursor events, and initiate at least one of the precursor events for the user based on the predicted event data.

A non-transitory computer readable medium storing code for data analytics is described. In some examples, the code comprises instructions executable by a processor to: receive attribute data for a user, predict event data for each of a plurality of precursor events based on the attribute data, wherein the event data represents a probability of each of the precursor events, the event data is predicted using a neural network that produces an output for each of the precursor events, and the neural network is trained using a first loss function that compares a function of the output to individual level training data for an outcome event that is based at least in part on the precursor events, and initiate at least one of the precursor events for the user based on the predicted event data.

In some examples, the neural network is trained based on a second loss function that compares an aggregate output from a plurality of predictions to aggregate level training data for at least one of the precursor events. Some examples of the method, apparatus, and non-transitory computer readable medium described above further include collecting the individual level training data for the outcome event based on direct user interactions. Some examples further include receiving the aggregate level training data for the at least one of the precursor events from a third party.

In some examples, the neural network is trained based on a third loss function that smooths an aggregate loss term from the second loss function over a plurality of training batches. Some examples of the method, apparatus, and non-transitory computer readable medium described above further include collecting interaction data for the user, wherein the attribute data is based on the interaction data.

In some examples, the function of the output comprises a product of the output for each of the precursor events. In some examples, the first loss function comprises a binary cross entropy function. Some examples of the method, apparatus, and non-transitory computer readable medium described above further include updating a marketing strategy for the user based on the predicted event data, wherein the at least one of the precursor events comprises a marketing event, and the initiating of the at least one of the precursor events is based on the marketing strategy.

A method for training a neural network to perform data analytics is described. Embodiments of the method include receiving attribute data for a plurality of users, receiving individual level training data corresponding to an outcome event based at least in part on a plurality of precursor events, predicting event data for each of the precursor events based on the attribute data, wherein the event data represents a probability of each of the precursor events, computing a function of the event data for each of the users, comparing the function of the event data to the individual level training data according to a first loss function, and updating the neural network based on the comparison according to the first loss function.

An apparatus for training a neural network to perform data analytics is described. The apparatus includes a processor, memory in electronic communication with the processor, and instructions stored in the memory. The instructions are operable to cause the processor to receive attribute data for a plurality of users, receive individual level training data corresponding to an outcome event based at least in part on a plurality of precursor events, predict event data for each of the precursor events based on the attribute data, wherein the event data represents a probability of each of the precursor events, compute a function of the event data for each of the users, compare the function of the event data to the individual level training data according to a first loss function, and update the neural network based on the comparison according to the first loss function.

A non-transitory computer readable medium storing code for training a neural network to perform data analytics is described. In some examples, the code comprises instructions executable by a processor to: receive attribute data for a plurality of users, receive individual level training data corresponding to an outcome event based at least in part on a plurality of precursor events, predict event data for each of the precursor events based on the attribute data, wherein the event data represents a probability of each of the precursor events, compute a function of the event data for each of the users, compare the function of the event data to the individual level training data according to a first loss function, and update the neural network based on the comparison according to the first loss function.

In some examples, the first loss function comprises a binary cross entropy function. In some examples, the function of the output comprises a product of the event data for each of the precursor events. Some examples of the method, apparatus, and non-transitory computer readable medium described above further include receiving aggregate level training data for at least one of the precursor events. Some examples further include comparing the predicted event data for the at least one of the precursor events to the aggregate level training data according to a second loss function, wherein the updating of the neural network is further based on the comparison according to the second loss function.

Some examples of the method, apparatus, and non-transitory computer readable medium described above further include collecting the individual level training data for the outcome event based on direct user interactions. Some examples further include receiving the aggregate level training data for the at least one of the precursor events from a third party. Some examples of the method, apparatus, and non-transitory computer readable medium described above further include comparing the predicted event data for the at least one of the precursor events over a plurality of training batches according to a third loss function, wherein the updating of the neural network is further based on the comparison according to the third loss function.

Some examples of the method, apparatus, and non-transitory computer readable medium described above further include collecting interaction data for the users, wherein the attribute data is based on the interaction data. Some examples of the method, apparatus, and non-transitory computer readable medium described above further include updating a marketing strategy for the user based on the predicted event data, wherein the at least one of the precursor events comprises a marketing event, and initiating the at least one of the precursor events is based on the marketing strategy.

An apparatus for data analytics is described. Embodiments of the apparatus include an input component configured to receive attribute data for users and a neural network configured to predict event data for each of a plurality of precursor events based on the attribute data, wherein the event data represents a probability of each of the precursor events, and the neural network is trained using a first loss function that compares a function of the event data to individual level training data for an outcome event that is based at least in part on the precursor events.

A method of providing an apparatus for data analytics is described. The method includes an input component configured to receive attribute data for users and a neural network configured to predict event data for each of a plurality of precursor events based on the attribute data, wherein the event data represents a probability of each of the precursor events, and the neural network is trained using a first loss function that compares a function of the event data to individual level training data for an outcome event that is based at least in part on the precursor events.

In some examples, the neural network comprises a multi-layer perceptron (MLP). In some examples, the neural network is further trained based on a second loss function comparing the predicted event data for at least one of the precursor events to aggregate level training data for the at least one of the precursor events. In some examples, the neural network is further trained based on a third loss function smoothing the output of the second loss function over a plurality of training batches.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also, the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
receiving attribute data for at least one user;
identifying a plurality of precursor events causally related to an observable target interaction with the at least one user, wherein at least one of the precursor events comprises a marketing event;
predicting a probability for each of the precursor events based on the attribute data using a neural network trained with a first loss function comparing individual level training data for the observable target interaction; and
performing the marketing event directed to the at least one user based at least in part on the predicted probabilities.

2. The method of claim 1, wherein:
the neural network is further trained based on a second loss function comparing an aggregate output from a plurality of predictions to aggregate level training data for at least one of the precursor events.

3. The method of claim 2, further comprising:
collecting the individual level training data for the observable target interaction based on direct monitoring of user interactions; and
receiving the aggregate level training data for the at least one of the precursor events from a third party, wherein individual level data for the precursor events is not available.

4. The method of claim 2, wherein:
the neural network is trained based on a third loss function that smooths an aggregate loss term from the second loss function over a plurality of training batches.

5. The method of claim 1, further comprising:
collecting interaction data for the at least one user, wherein the attribute data is based on the interaction data.

6. The method of claim 1, wherein:
the first loss function is based on a product of the probability for each of the precursor events.

7. The method of claim 1, wherein:
the first loss function comprises a binary cross entropy function.

8. The method of claim 1, further comprising:
updating a marketing strategy based on the predicted probabilities, wherein the marketing event is performed based on the marketing strategy.

9. A method of training a neural network, the method comprising:
receiving attribute data for a plurality of users;
receiving individual level training data for the users corresponding to an observable target interaction causally related to a plurality of precursor events;
predicting event data for each of the precursor events based on the attribute data, wherein the event data includes a probability of an occurrence of a corresponding precursor event;
computing a product of the event data for each of the users;
comparing the product of the event data to the individual level training data using a first loss function; and
updating the neural network based on the comparison.

10. The method of claim 9, wherein:
the first loss function comprises a binary cross entropy function.

11. The method of claim 9, wherein:
the product of the event data comprises a multiplicative product of the event data for each of the precursor events.

12. The method of claim 9, further comprising:
receiving aggregate level training data for at least one of the precursor events; and
comparing the predicted event data for the at least one of the precursor events to the aggregate level training data according to a second loss function, wherein the neural network is further updated based on the second loss function.

13. The method of claim 12, further comprising:
collecting the individual level training data for the observable target interaction based on direct user interactions; and
receiving the aggregate level training data for the at least one of the precursor events from a third party.

14. The method of claim 12, further comprising:
comparing the predicted event data for the at least one of the precursor events over a plurality of training batches according to a third loss function, wherein the neural network is further updated based on the third loss function.

15. The method of claim 9, further comprising:
collecting interaction data for the users, wherein the attribute data is based on the interaction data.

16. The method of claim 9, further comprising:
updating a marketing strategy for the user based on the predicted event data; and
initiating at least one of the precursor events based on the marketing strategy.

17. An apparatus comprising:
an input component configured to receive attribute data for a plurality of users; and
a neural network configured to predict a probability for each of a plurality of precursor events that are causally related to an observable target interaction with the users, wherein the neural network is trained using a first loss function comparing individual level training data for the observable target interaction.

18. The apparatus of claim 17, wherein:
the neural network comprises a multi-layer perceptron (MLP).

19. The apparatus of claim 17, wherein:
the neural network is further trained based on a second loss function comparing the predicted event data for at least one of the precursor events to aggregate level training data for the at least one of the precursor events.

20. The apparatus of claim 19, wherein:
the neural network is further trained based on a third loss function smoothing an output of the second loss function over a plurality of training batches.
